(19) United States
(12) Patent Application Publication
(10) Pub. No.: US 2024/0097762 A1
(43) Pub. Date: Mar. 21, 2024

(54) METHOD AND APPARATUS FOR CHANNEL STATE INFORMATION REPORTING

(71) Applicant: MediaTek Singapore Pte. Ltd., Singapore (SG)

(72) Inventors: Gyu Bum KYUNG, San Jose, CA (US); Lung-Sheng TSAI, Hsinchu City (TW)

(21) Appl. No.: 17/766,916

(22) PCT Filed: Feb. 5, 2021
(86) PCT No.: PCT/CN2021/075523

§ 371 Date: Apr. 6, 2022

Related U.S. Application Data
(60) Provisional application No. 62/970,784, filed on Feb. 6, 2020.

(51) Int. Cl. H04B 7/06; H04B 7/024

(52) U.S. Cl. CPC H04B 7/0626; H04B 7/024

(57) ABSTRACT

A method pertaining to channel state information (CSI) reporting for multiple transmission/reception-points (multi-TRP) in next-generation mobile communications involves a user equipment (UE) generating a CSI report for multiple TRPs in communications with the UE. Additionally, the method also involves the UE transmitting the CSI report to one or more of the multiple TRPs using one or multiple CSI reporting resources.

### CROSS REFERENCE TO RELATED PATENT APPLICATION

The present disclosure claims the priority benefit of U.S. Provisional Patent Application Nos. 62/970,784, filed 6 Feb. 2020, respectively, the content of which being incorporated by reference in its entirety.

### TECHNICAL FIELD

The present disclosure is generally related to wireless communications and, more particularly, to channel state information (CSI) reporting in mobile communications.

### BACKGROUND

Unless otherwise indicated herein, approaches described in this section are not prior art to the claims listed below and are not admitted as prior art by inclusion in this section.

Under the 3^{rd} Generation Partnership Project (3GPP) specification for New Radio (NR) regarding multiple-transmission/reception-point (multi-TRP) scheme, a user equipment (UE) could communicate at the same time to more than one TRPs that are physically separated in different locations. Multi-TRP is essential for the UE especially when the UE is located near a cell edge as the UE, when at the cell edge, could suffer from higher path loss from a serving TRP in addition to higher interference from neighboring TRPs. Accordingly, joint or coordinated transmissions among the TRPs could increase spectral efficiency and reliability especially for blockage channel. Thus, different TRPs would need various coding schemes and interference avoidance/cancellation schemes.

In Release 15 (Rel-15) of the 3GPP specification, a CSI framework provides flexibility to acquire various types of single-TRP based CSI (namely, single-user CSI (SU-CSI) and multiple-user CSI (MU-CSI)) and some types of multi-TRP CSI by proper settings of channel measurement resource (CMR), CSI resource for interference measurement (CSI-IM), nonzero power interference measurement resource (NZP-IMR). For instance, with respect to dynamic point selection (DPS) CSI, a first CSI (CSI #1) could include a CMR from a first TRP (TRP1) and an NZP-IMR from a second TRP (TRP2), and a second CSI (CSI #2) could include a CMR from TRP2 and an NZP-IMR from TRP1. However, CSI for coordinated non-coherent joint transmission (NCJT) has not yet been discussed in Release 16 (Rel-16) of the 3GPP specification. For example, depending on the scenario, CSI reporting for multi-TRP needs to be defined for scenarios such as downlink control information (DCI)-based CSI reporting, multiple DCI-based CSI reporting, ideal backhaul scenarios, non-ideal backhaul scenarios, and so forth. Therefore, there is a need of a solution for CSI reporting for multi-TRP scenarios.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to CSI reporting for multi-TRP in next-generation mobile communications.

In one aspect, a method may involve a UE generating a CSI report for multiple TRPs in communications with the UE. The method may also involve the UE transmitting the CSI report to one or more of the multiple TRPs using one or multiple CSI reporting resources.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview

Implementations in accordance with the present disclosure relate to various techniques, methods, schemes and/or solutions pertaining to CSI reporting for multi-TRP in next-generation mobile communications. According to the present disclosure, a number of possible solutions may be implemented separately or jointly. That is, although these possible solutions may be described below separately, two or more of these possible solutions may be implemented in one combination or another.

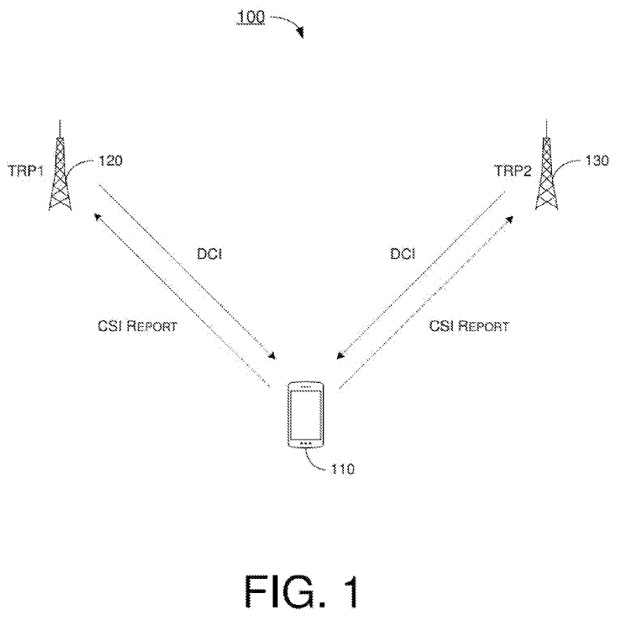

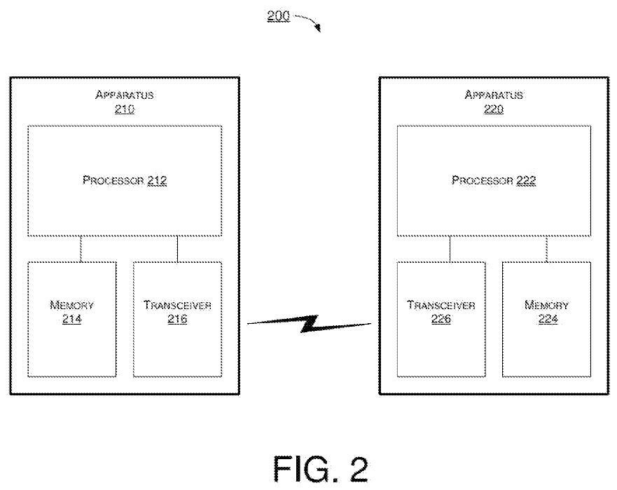

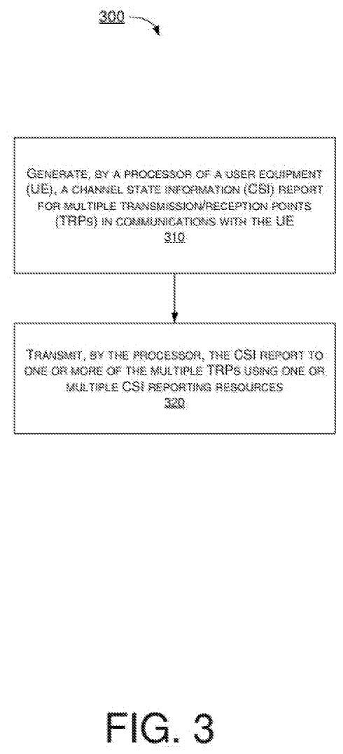

FIG. 1 illustrates an example network environment 100 in which various solutions and schemes in accordance with the present disclosure may be implemented. FIG. 2˜FIG. 3 illustrate examples of implementation of various proposed schemes in network environment 100 in accordance with the present disclosure. The following description of various proposed schemes is provided with reference to FIG. 1˜FIG. 3.

Referring to FIG. 1, network environment 100 may involve at least a UE 110 communicating wirelessly with a first TRP 120 (herein interchangeably denoted as TRP1) and a second TRP 130 (herein interchangeably denoted as TRP2). Each of UE 110, TRP 120 and TRP 130 may be configured to communicate with each other with by implementing one or more of the proposed scheme regarding CSI reporting for multi-TRP in next-generation mobile communications described below.

It is noteworthy that, in Release 14 (Rel-14) of the 3GPP specification for Long-Term Evolution (LTE) regarding Further Enhanced Coordinated Multi-Point (feCoMP), it is defined that CSI resource index (CRI)=2 CSI reporting being performed for both NZP CSI-RS resources. Moreover, two sets of CSIs (including precoding matrix indicator, channel quality indicator and rank indication (PMI/CQI/RI)) are calculated within a single CSI process based on K=two NZP CSI-RS resources. Each set of CSI corresponds to each codeword. CSI of one codeword is calculated based on interference assumption that inter-codeword interference is derived from the CSI-RS resource corresponding to the other codeword.

Under a proposed scheme in accordance with the present disclosure, CSI reporting for multi-TRP may be single DCI-based in that one physical downlink control channel (PDCCH) may schedule multiple physical downlink shared channel (PDSCH) transmission occasions. More specifically, each PDSCH transmission occasion (shared resources) may be associated with one or more codewords or transport blocks (TBs). Moreover, under the proposed scheme, single DCI-based CSI reporting may be performed using multiple CSI reporting resources such as, for example and without limitation, physical uplink control channel (PUCCH), physical uplink shared channel (PUSCH) or a hybrid thereof. For instance, when UE 110 reports CSI targeted for at least two TRPs (e.g., TRP 120 and TRP 130), one PUCCH resource indicator (PRI) (e.g., due to one DCI being received) may indicate two resources by offset targeted for the two TRPs (e.g., with two spatial relations in frequency range 2 (FR2)). Additionally, under the proposed scheme, the same single CSI report may be reported to both or all TRPs. This single CSI report may contain one CSI report for one or more codewords. Accordingly, the two TRPs would not need to coordinate with each other because the TRPs would receive the same content. Alternatively, under the proposed scheme, one CSI reporting resource may be shared jointly by the TRPs. That is, UE 110 may transmit the CSI report to one representative TRP of multiple TRPs (e.g., TRP 120 and TRP 130). This may be beneficial for scenarios of ideal backhaul with TRP coordination among/between the multiple TRPs. It is noteworthy that a given CSI report may include information regarding hybrid automatic repeat request (HARQ), CQI, RI, PMI and other relevant information.

Under a proposed scheme in accordance with the present disclosure, CSI reporting for multi-TRP may be multiple DCI-based in that multiple PDCCHs may schedule corresponding PDSCH transmissions. Under the proposed scheme, there may be three different approaches to multiple DCI-based CSI reporting for multi-TRP, namely: a joint CSI approach, a separate CSI approach, and a hybrid CSI approach. Under the joint CSI approach, UE 110 may transmit a joint CSI which contain multiple CSI reports each for a corresponding TRP of multiple TRPs (e.g., TRP 120 and TRP 130). Under this approach, the joint CSI may be transmitted to one representative TRP of multiple TRPs. This may be beneficial when the multiple TRPs are coordinating with each other with ideal backhaul. When UE 110 combines multiple CSI reports, UE 110 may multiplex each CSI report in an increasing or decreasing order according to a TRP index associated with each TRP of the multiple TRPs. Furthermore, UE 110 may multiplex content items of the multiple CSI reports in an alternating order. For instance, when there are two TRPs, such as TRP1 and TRP2, UE 110 may multiplex two CSI reports as follows: (CSI report 1 (HARQ, CQI, RI, PMI and so on for TRP1), CSI report 2 (HARQ, CQI, RI, PMI and so on for TRP2)). Alternatively, UE 110 may multiplex by alternating contents of multiple CSI reports. For instance, when there are two TRPs, such as TRP1 and TRP2, UE 110 may multiple two CSI reports as follows: (HARQ for TRP1, HARQ for TRP2, CQI for TRP1, CQI for TRP2, RI for TRP1, RI for TRP2, and so on), with the order of each item following the rule used in CSI reporting for a single TRP.

Under the separate CSI approach, UE 110 may transmit multiple independent CSI reports to each of multiple TRPs individually. For instance, each DCI transmission of multiple DCI transmissions in the multiple DCI-based CSI reporting may trigger a corresponding CSI reporting targeted for the same TRP. Under the hybrid CSI approach, a joint CSI may include all CSI reports for all PDSCH transmissions by UE 110. For instance, the joint CSI may be transmitted by UE 110 to all TRPs involved. This may be beneficial for TRPs without coordination for non-ideal backhaul scenarios.

In view of the above, a summary of various proposed schemes pertaining to CSI reporting for multi-TRP in next-generation mobile communications is provided below.

In one aspect, when utilizing one PDCCH to schedule multiple PDSCH transmissions with each PDSCH transmission being associated with one or more codewords or TBs, UE 110 may transmit a single CSI report targeted for all TRPs using multiple CSI reporting resources (e.g., PUCCHs and/or PUSCHs). Accordingly, the same single CSI report may be reported to two or more TRPs (e.g., TRP 120 and TRP 130), and this single CSI report may contain the CSI report for one or more codewords. In such cases, it would not be necessary for the multiple TRPs to coordinate with each other as the same content (of CSI report) would be received by the TRPs. Moreover, multiple CSI resources may be indicated by one resource indicator with one or more offset values.

In another aspect, when utilizing one PDCCH to schedule multiple PDSCH transmissions with each PDSCH transmission being associated with one or more codewords or TBs, UE 110 may transmit a single CSI report targeted for multiple TRPs using one CSI reporting resource (e.g., PUCCH or PUSCH). Accordingly, the same single CSI report may be reported to one representative TRP of the multiple TRPs.

In yet another aspect, when utilizing multiple PDCCHs to schedule multiple PDSCH transmissions with each PDSCH transmission associated with one or more codewords or TBs, UE 110 may transmit a joint CSI report which includes multiple CSI reports for multiple TRPs using one CSI reporting resource (e.g., PUCCH or PUSCH). Accordingly, the same single CSI report may be reported to one representative TRP of the multiple TRPs. This single CSI report may contain the CSI report for one or more codewords. When UE 110 combines multiple CSI reports, UE 110 may multiplex the multiple CSI reports in an increasing or decreasing order according to the TRP index associated with each TRP of the multiple TRPs. Alternatively, UE 110 may multiplex content items of the multiple CSI reports in an alternating order.

In still another aspect, when utilizing multiple PDCCHs to schedule multiple PDSCH transmissions with each PDSCH transmission associated with one or more codewords or TBs, UE 110 may transmit separate CSI reports by transmitting a single CSI report to a corresponding TRP of multiple TRPs using multiple CSI reporting resources (e.g., PUCCHs and/or PUSCHs). Accordingly, each of multiple independent CSI reports may be transmitted to a corresponding one of the multiple TRPs. Moreover, each DCI transmission of multiple DCI transmissions in the multiple DCI-based CSI reporting may trigger a corresponding CSI reporting targeted for the same TRP.

In one aspect, when utilizing multiple PDCCHs to schedule each corresponding PDSCH transmission of multiple PDSCH transmissions with each PDSCH transmission associated with one or more codewords or TBs, UE 110 may transmit a joint CSI report (which may include multiple CSI reports for multiple TRPs) to the multiple TRPs using multiple CSI reporting resources (e.g., PUCCHs and/or PUSCHs). Accordingly, a given joint CSI report may contain the same CSI report for the multiple TRPs.

Illustrative Implementations

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to CSI reporting for multi-TRP in next-generation mobile communications, including the various schemes described above with respect to various proposed designs, concepts, schemes, systems and methods described above as well as processes described below. For instance, apparatus 210 may be implemented in UE 110 and apparatus 220 may be implemented in TRP 120 or TRP 130, or vice versa.

Each of apparatus 210 and apparatus 220 may be a part of an electronic apparatus, which may be a UE or a TRP, such as a portable or mobile apparatus, a wearable apparatus, a wireless communication apparatus or a computing apparatus. When implemented in a UE, each of apparatus 210 and apparatus 220 may be implemented in a smartphone, a smart watch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in a network node, such as a TRP in an NR mobile network.

In some implementations, each of apparatus 210 and apparatus 220 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 210 and apparatus 220 may be implemented in or as a UE or a TRP. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to CSI reporting for multi-TRP in next-generation mobile communications in accordance with various implementations of the present disclosure.

In some implementations, apparatus 210 may also include a transceiver 216 coupled to processor 212. Transceiver 216 may include a transmitter capable of wirelessly transmitting and a receiver capable of wirelessly receiving data. In some implementations, apparatus 220 may also include a transceiver 226 coupled to processor 222. Transceiver 226 may include a transmitter capable of wirelessly transmitting and a receiver capable of wirelessly receiving data. It is noteworthy that, although transceiver 216 and transceiver 226 are illustrated as being external to and separate from processor 212 and processor 222, respectively, in some implementations, transceiver 216 may be an integral part of processor 212 as a system on chip (SoC) and/or transceiver 226 may be an integral part of processor 222 as a SoC.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as UE 110, and apparatus 220, as TRP 120 or TRP 130, is provided below. It is noteworthy that, although a detailed description of capabilities, functionalities and/or technical features of apparatus 210 is provided below, the same may be applied to apparatus 220 although a detailed description thereof is not provided solely in the interest of brevity. It is also noteworthy that, although the example implementations described below are provided in the context of WLAN, the same may be implemented in other types of networks.

Under a proposed scheme pertaining to CSI reporting for multi-TRP in next-generation mobile communications in accordance with the present disclosure, with apparatus 210 implemented in or as UE 110 and apparatus 220 implemented in or as TRP 120 or TRP 130 in network environment 100, processor 212 of apparatus 210 may generate a CSI report for multiple TRPs which are in communications with apparatus 210. Moreover, processor 212 may transmit, via transceiver 216, the CSI report to one or more of the multiple TRPs (including apparatus 220 as TRP 120 or TRP 130) using one or multiple CSI reporting resources.

In some implementations, in transmitting the CSI report, processor 212 may utilize one PDCCH to schedule multiple PDSCH transmissions with each of the multiple PDSCH transmissions associated with one or more codewords or TBs. In such cases, in transmitting the CSI report to the one or more of the multiple TRPs, processor 212 may transmit a same CSI report for one or more codewords to the multiple TRPs such that there is no coordination between or among the multiple TRPs. Alternatively, in transmitting the CSI report to the one or more of the multiple TRPs, processor 212 may transmit the CSI report using multiple CSI reporting resources. In some implementations, the multiple CSI reporting resources may include one or more PUCCHs, one or more PUSCHs, or a combination thereof. Moreover, the multiple CSI reporting resources may be indicated by one resource indicator with one or more offset values.

In some implementations, in transmitting the CSI report to the one or more of the multiple TRPs, processor 212 may transmit the CSI report using one CSI reporting resource. In such cases, the one CSI reporting resource may include a PUCCH or a PUSCH. Moreover, in transmitting the CSI report to the one or more of the multiple TRPs, processor 212 may transmit a single CSI report for one representative TRP of the multiple TRPs.

In some implementations, in generating the CSI report for the multiple TRPs, processor 212 may multiplex multiple CSI reports, each for a corresponding one of the multiple TRPs, to generate a joint CSI report. For instance, in multiplexing the multiple CSI reports, processor 212 may multiplex the multiple CSI reports in an increasing or decreasing order according to a TRP index associated with each TRP of the multiple TRPs. Alternatively, in multiplexing the multiple CSI reports, processor 212 may multiplex content items of the multiple CSI reports in an alternating order. In some implementations, in transmitting the CSI report to the one or more of the multiple TRPs, processor 212 may transmit the joint CSI report using one CSI reporting resource, which may include a PUCCH or a PUSCH. Moreover, in transmitting the joint CSI report, processor 212 may transmit the joint CSI report for one representative TRP of the multiple TRPs.

In some implementations, in generating the CSI report, processor 212 may generate multiple independent CSI reports for the multiple TRPs. In such cases, in transmitting the CSI report, processor 212 may utilize one PDCCH to schedule multiple PDSCH transmissions with each of the multiple PDSCH transmissions associated with one or more codewords or TBs. For instance, in transmitting the CSI report to the one or more of the multiple TRPs, processor 212 may transmit each of the multiple independent CSI reports by transmitting to a corresponding one of the multiple TRPs. Moreover, each DCI transmission of multiple DCI transmissions in the multiple DCI-based CSI reporting may trigger a corresponding CSI reporting targeted for the same TRP of the multiple TRPs.

In some implementations, in generating the CSI report, processor 212 may generate a joint CSI report comprising multiple independent CSI reports for the multiple TRPs. In such cases, in transmitting the CSI report to the one or more of the multiple TRPs, processor 212 may transmit the joint CSI report to the multiple TRPs using multiple CSI reporting resources, which may include one or more PUCCHs, one or more PUSCHs, or a combination thereof.

Illustrative Processes

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to CSI reporting for multi-TRP in next-generation mobile communications in accordance with the present disclosure. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 implemented in or as UE 110 and apparatus 220 implemented in or as TRP 120 or TRP 130 of a wireless network such as an NR mobile network in network environment 100 in accordance with one or more of 3GPP specifications (e.g., Rel-16). Process 300 may begin at block 310.

At 310, process 300 may involve processor 212 of apparatus 210 (e.g., UE 110)generating a CSI report for multiple TRPs which are in communications with apparatus 210. Process 300 may proceed from 310 to 320.

At 320, process 300 may involve processor 212 transmitting, via transceiver 216, the CSI report to one or more of the multiple TRPs (including apparatus 220 as TRP 120 or TRP 130) using one or multiple CSI reporting resources.

In some implementations, in transmitting the CSI report, process 300 may involve processor 212 utilizing one PDCCH to schedule multiple PDSCH transmissions with each of the multiple PDSCH transmissions associated with one or more codewords or TBs. In such cases, in transmitting the CSI report to the one or more of the multiple TRPs, process 300 may involve processor 212 transmitting a same CSI report for one or more codewords to the multiple TRPs such that there is no coordination between or among the multiple TRPs. Alternatively, in transmitting the CSI report to the one or more of the multiple TRPs, process 300 may involve processor 212 transmitting the CSI report using multiple CSI reporting resources. In some implementations, the multiple CSI reporting resources may include one or more PUCCHs, one or more PUSCHs, or a combination thereof. Moreover, the multiple CSI reporting resources may be indicated by one resource indicator with one or more offset values.

In some implementations, in transmitting the CSI report to the one or more of the multiple TRPs, process 300 may involve processor 212 transmitting the CSI report using one CSI reporting resource. In such cases, the one CSI reporting resource may include a PUCCH or a PUSCH. Moreover, in transmitting the CSI report to the one or more of the multiple TRPs, process 300 may also involve processor 212 transmitting a single CSI report for one representative TRP of the multiple TRPs.

In some implementations, in generating the CSI report for the multiple TRPs, process 300 may involve processor 212 multiplexing multiple CSI reports, each for a corresponding one of the multiple TRPs, to generate a joint CSI report. For instance, in multiplexing the multiple CSI reports, process 300 may involve processor 212 multiplexing the multiple CSI reports in an increasing or decreasing order according to a TRP index associated with each TRP of the multiple TRPs. Alternatively, in multiplexing the multiple CSI reports, process 300 may involve processor 212 multiplexing content items of the multiple CSI reports in an alternating order. In some implementations, in transmitting the CSI report to the one or more of the multiple TRPs, process 300 may involve processor 212 transmitting the joint CSI report using one CSI reporting resource, which may include a PUCCH or a PUSCH. Moreover, in transmitting the joint CSI report, process 300 may involve processor 212 transmitting the joint CSI report for one representative TRP of the multiple TRPs.

In some implementations, in generating the CSI report, process 300 may involve processor 212 generating multiple independent CSI reports for the multiple TRPs. In such cases, in transmitting the CSI report, process 300 may involve processor 212 utilizing one PDCCH to schedule multiple PDSCH transmissions with each of the multiple PDSCH transmissions associated with one or more codewords or TBs. For instance, in transmitting the CSI report to the one or more of the multiple TRPs, process 300 may involve processor 212 transmitting each of the multiple independent CSI reports by transmitting to a corresponding one of the multiple TRPs. Moreover, each DCI transmission of multiple DCI transmissions in the multiple DCI-based CSI reporting may trigger a corresponding CSI reporting targeted for the same TRP of the multiple TRPs.

In some implementations, in generating the CSI report, process 300 may involve processor 212 generating a joint CSI report comprising multiple independent CSI reports for the multiple TRPs. In such cases, in transmitting the CSI report to the one or more of the multiple TRPs, process 300 may involve processor 212 transmitting the joint CSI report to the multiple TRPs using multiple CSI reporting resources, which may include one or more PUCCHs, one or more PUSCHs, or a combination thereof.

Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
generating, by a processor of a user equipment (UE), a channel state information (CSI) report for multiple transmission/reception points (TRPs) in communications with the UE; and
transmitting, by the processor, the CSI report to one or more of the multiple TRPs using one or multiple CSI reporting resources.

2. The method of claim 1, wherein the transmitting of the CSI report comprises utilizing one physical downlink control channel (PDCCH) to schedule multiple physical downlink shared channel (PDSCH) transmissions with each of the multiple PDSCH transmissions associated with one or more codewords or transport blocks (TBs).

3. The method of claim 2, wherein the transmitting of the CSI report to the one or more of the multiple TRPs comprises transmitting a same CSI report for one or more codewords to the multiple TRPs such that there is no coordination between or among the multiple TRPs.

4. The method of claim 2, wherein the transmitting of the CSI report to the one or more of the multiple TRPs comprises transmitting the CSI report using multiple CSI reporting resources.

5. The method of claim 4, wherein the multiple CSI reporting resources comprise one or more physical uplink control channels (PUCCHs), one or more physical uplink shared channels (PUSCHs), or a combination thereof.

6. The method of claim 4, wherein the multiple CSI reporting resources are indicated by one resource indicator with one or more offset values.

7. The method of claim 1, wherein the transmitting of the CSI report to the one or more of the multiple TRPs comprises transmitting the CSI report using one CSI reporting resource.

8. The method of claim 7, wherein the one CSI reporting resource comprises a physical uplink control channels (PUCCH) or a physical uplink shared channel (PUSCH).

9. The method of claim 7, wherein the transmitting of the CSI report to the one or more of the multiple TRPs further comprises transmitting a single CSI report for one representative TRP of the multiple TRPs.

10. The method of claim 1, wherein the generating of the CSI report for the multiple TRPs comprises multiplexing multiple CSI reports, each for a corresponding one of the multiple TRPs, to generate a joint CSI report.

11. The method of claim 10, wherein the multiplexing of the multiple CSI reports comprises multiplexing the multiple CSI reports in an increasing or decreasing order according to a TRP index associated with each TRP of the multiple TRPs.

12. The method of claim 10, wherein the multiplexing of the multiple CSI reports comprises multiplexing content items of the multiple CSI reports in an alternating order.

13. The method of claim 10, wherein the transmitting of the CSI report to the one or more of the multiple TRPs comprises transmitting the joint CSI report using one CSI reporting resource.

14. The method of claim 13, wherein the one CSI reporting resource comprises a physical uplink control channels (PUCCH) or a physical uplink shared channel (PUSCH).

15. The method of claim 13, wherein the transmitting of the joint CSI report comprises transmitting the joint CSI report for one representative TRP of the multiple TRPs.

16. The method of claim 1, wherein the generating of the CSI report comprises generating multiple independent CSI reports for the multiple TRPs, and wherein the transmitting of the CSI report comprises utilizing one physical downlink control channel (PDCCH) to schedule multiple physical downlink shared channel (PDSCH) transmissions with each of the multiple PDSCH transmissions associated with one or more codewords or transport blocks (TBs).

17. The method of claim 16, wherein the transmitting of the CSI report to the one or more of the multiple TRPs comprises transmitting each of the multiple independent CSI reports by transmitting to a corresponding one of the multiple TRPs.

18. The method of claim 17, wherein each downlink control information (DCI) transmission of multiple DCI transmissions triggers transmission of a corresponding one of the multiple independent CSI reports targeted for a same TRP of the multiple TRPs.

19. The method of claim 1, wherein the generating of the CSI report comprises generating a joint CSI report comprising multiple independent CSI reports for the multiple TRPs.

20. The method of claim 19, wherein the transmitting of the CSI report to the one or more of the multiple TRPs comprises transmitting the joint CSI report to the multiple TRPs using multiple CSI reporting resources, and wherein the multiple CSI reporting resources comprise one or more physical uplink control channels (PUCCHs), one or more physical uplink shared channels (PUSCHs), or a combination thereof.
